(19) United States
(12) Patent Application Publication
(10) Pub. No.: US 2004/0008676 A1
(43) Pub. Date: Jan. 15, 2004

(54) Method and device for using an address indicator in a network

(76) Inventor: David Andrew Thomas, Atherton, CA (US)

Correspondence Address: HEWLETT-PACKARD COMPANY, Intellectual Property Administration, P.O. Box 272400, Fort Collins, CO, 80527-2400, US

(21) Appl. No.: 10/192,632

(22) Filed: Jul. 11, 2002

(51) Int. Cl. H04L 12/28

(52) U.S. Cl. 370/389; 370/401; 370/466

(57) ABSTRACT

A first network device is configured to receive an information packet including a destination address from a source node. The first network device includes a first translation table for use in translating the destination address into an address indicator which is used in the computer network system to replace the destination address in the information packet and to denote a destination node specified by the destination address. A second network device is configured to receive the information packet including the address indicator. The second network device including a second translation table for use in translating the address indicator into the destination address. The second network device being configured to send the information packet including the destination address to the destination node denoted by the address indicator.

### BACKGROUND OF THE INVENTION

1. Field of Invention

The present invention relates generally to network devices and to computer network systems which comprise network devices.

2. Background Information

Computer network systems, such as Local Area Networks (LANs), use network devices to interconnect nodes. Many computer network systems are implemented using Ethernet to provide a relatively high bandwidth interconnection of many nodes.

The nodes of a computer network system communicate using an established communication protocol to achieve point to point communication. Often, these protocols also include a multicast mechanism to send a data packet to multiple end nodes, and include a broadcast mechanism to send a data packet to all end nodes. This broadcast mechanism can limit the scaleability of a computer network system.

In addition to a broadcast mechanism, other techniques exist for directing a data packet to an end node. The virtual LAN (VLAN) standard allows for grouping nodes into Logical LAN groupings on a single fabric. In a VLAN environment, packets are assigned to a particular logical LAN and the packet is constrained to stay within that logical LAN. This ensures that unicast packets cannot be received outside of a particular grouping. Broadcast and multicast packets from a given node with a virtual LAN are similarly constrained to remain within the virtual LAN. The traffic containment that VLAN's provide, along with the controlled distribution of multicast packets, can permit a greater number of end nodes to be supported on a fabric. The IEEE VLAN standard has limited the length of a VLAN tag used to define the number of possible VLAN's within a computer network system to 12 bits.

### SUMMARY OF THE INVENTION

Exemplary embodiments of the present invention are directed to providing a computer network system for interconnecting nodes using an address indicator. An exemplary computer network system for interconnecting nodes includes a first network device configured to receive an information packet including a destination address from a source node. The first network device includes a first translation table for use in translating the destination address into an address indicator which is used in the computer network system to replace the destination address in the information packet and to denote a destination node specified by the destination address. The computer network system also includes a second network device configured to receive the information packet including the address indicator. The second network device includes a second translation table for use in translating the address indicator into the destination address. The second network device can be configured to send the information packet, including the destination address, to the destination node denoted by the address indicator.

Exemplary embodiments of the present invention are also directed to a network device using an address indicator, the network device comprising first and second ports. The network device can be configured to receive an information packet including a destination address across the first port. The network device includes a translation unit, including a translation table for use in translating the destination address into an address indicator which is used to replace the destination address in the information packet and to denote a destination node specified by the destination address. The network device can be configured to transfer the information packet, including the address indicator, across the second port.

The present invention is also directed to a method for controlling communications in a computer network system using an address indicator. An exemplary method comprises receiving an information packet with the destination address at a network device of the computer network system. At the network device, the destination address is translated into an address indicator which is used to replace the destination address in the information packet and to denote a destination node specified by the destination address. The information packet is sent with the address indicator from the network device.

### BRIEF DESCRIPTION OF THE DRAWINGS

FIG. 1 is a diagram of an exemplary embodiment of a computer network system of the present invention.

FIG. 2 is a diagram that illustrates an exemplary embodiment of a computer network system illustrating the use of tickets.

FIG. 3 is a diagram of an exemplary embodiment of a computer network system illustrating the use of group identifiers.

FIG. 4 is a diagram that illustrates the use of Ethernet packets in an exemplary embodiment of the present invention.

FIG. 5 is a diagram of an exemplary embodiment of a system according to the present invention.

FIG. 6 is a flowchart of an exemplary method of the present invention.

### DETAILED DESCRIPTION OF THE PREFERRED EMBODIMENTS

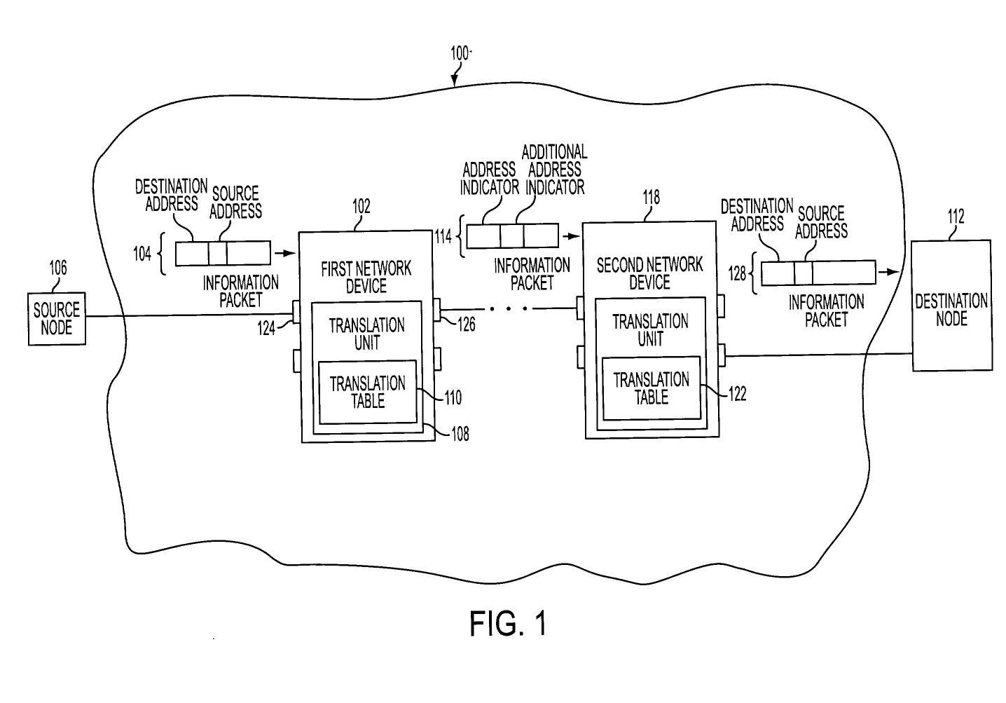

An exemplary embodiment of the present invention is a computer network system for interconnecting nodes using an address indicator, such as the computer network system 100 of FIG. 1. The computer network system includes a first network device configured to receive an information packet including a destination address from a source node.

In the FIG. 1 example, the computer network system 100 includes a first network device 102. The first network device 102 is configured to receive an information packet 104 including a destination address from a source node 106.

The words “destination” and “source” in the terms “destination node” and “source node” refer to the nodes without limiting the function of the nodes. For example, the source node can be a node which also receives information packets, and the destination node can be a node which also sends information packets. The destination address is an address associated with the destination node; and the source address is an address associated with the source node. In an exemplary embodiment, an information packet can enter the computer network from a source node directed to the destination node. In this case, the “destination address” can be stored in a destination address field and the “source address” can be stored in a source address field. For an information packet entering the computer network from the destination node directed to the source node, the “source address” can be stored in a destination address field and the “destination address” can be stored in a source address field.

In an exemplary embodiment, the first network device includes a first translation table, such as the translation table 110 of FIG. 1, for use in translating the destination address. The first translation table can be configured to translate the destination address into an address indicator which is used in the computer network system to replace the destination address in the information packet and to the denote a destination node specified by the destination address.

In an exemplary embodiment, the computer network system includes a second network device, such as second network device 118, configured to receive the information packet including the address indicator. The second network device including a second translation table, such as second translation table 122, for use in translating the address indicator into the destination address. The network device can be configured to send the information packet including the destination address to the destination node denoted by the address indicator.

In the example of FIG. 1, the translation table 110 stores a correspondence of an address with an address indicator. For example, the information packet received by the first network device 102 from the source node 106 includes the destination address of the destination node 112. The first network device 102 uses the translation table 110 to translate the destination address into an address indicator which replaces the destination address in the information packet.

In the FIG. 1 example, the destination address uniquely designates the destination node 112, and the address indicator is a ticket that uniquely identifies the destination node.

A broadcast address can be the destination address and the address indicator can be a group identifier used to indicate members of a group including the destination node 112. The use of the group identifier allows for a large number of logical LANs to be supported on the computer network system 100.

In the computer network system 100 of FIG. 1, address indicators can be used to forward information packets. As the information packets go into the computer network system, a network device, such as network device 102, can convert the externally-used destination addresses into address indicators for use in forwarding the information packets within the computer network system. When the information packets leave the computer network system, a second network device 118 can be used to translate the address indicator into the externally used destination addresses.

The translation table 110 can be a part of a translation unit 108. The translation unit 108 can be implemented in hardware or software to access the translation table 110 stored in memory.

The translation table can be implemented using an associative array. The translation table can be implemented using a hash table, such as a perfect hash table, or can be implemented in any suitable manner for achieving the desired correspondence of an address with an address indicator, such as a ticket or group indicator.

In one example, the translation tables including the first translation table 110 and second translation table 122 are implemented statically, with the association between the destination addresses and address indicators set by an administrator for the computer network system. Dynamic updating of the translation table can also be performed. The patent application entitled “Method And Device For Using Dynamic Updates In A Network” of David Andrew Thomas, (Attorney Docket No. HP-10014759), filed on even date herewith, and incorporated herein by reference, further describes dynamic updating of the translation table.

In the FIG. 1 example, some ports are connected to nodes and the association between a port and a node is used in the translation process. In this example, other ports are connected to additional network devices.

In an exemplary embodiment, the network devices can associate host addresses with certain specified ports of the network device to, for example, provide additional security for the computer network system.

The translation table can be initially configured by a system configurer. Current translation table entries or an initial state for the translation table can be mapped to a stable memory such as flash memory so that the table entries are maintained on power-down.

Destination addresses can include unicast addresses, broadcast addresses or multicast addresses. The address indicators can include tickets used for unicast addresses; group indicators used for broadcast addresses; and group indicators used for multicast addresses.

In an exemplary embodiment, the first network device can be configured to ensure that the source node and destination node belong to the same group before forwarding the information packet. In the example of FIG. 1, the first network device 102 checks to ensure that the source node 106 and destination node 112 belong to the same group before forwarding the information packet. The translation table 110 for a given address stores the corresponding address indicator and group identifier. If the group identifiers for the source address and destination address do not match, the network device does not forward the information packet.

The first network device can be configured to translate a source address into an additional address indicator that replaces the source address in the information packet.

In one example, the additional address indicator is used by another network device that forwards the information packet. The additional address indicator can be a ticket with a prefix of the ticket added to the forwarding table of the another network device.

The second network device can be configured to translate the additional address indicator into the source address that replaces the address indicator in the information packet.

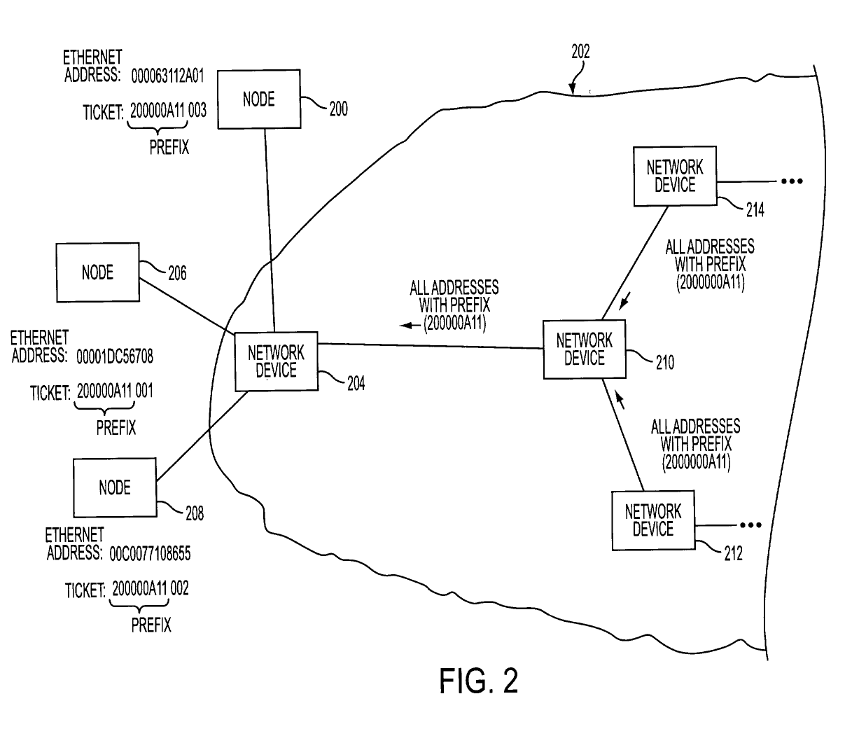

The address indicator can be a ticket that indicates a single destination node. In the example of FIG. 2, the ticket 20:00:00:A1:10:03 indicates the node 200. All information packets within the computer network 202 that use this ticket are sent to the network device 204 for forwarding to the node 200.

In an exemplary embodiment, tickets identifying nodes associated with a network device, such as the first or second network device, have a common prefix. In an exemplary embodiment, tickets identifying nodes associated with the second network device have a common prefix, including the ticket for the destination node.

In the FIG. 2 example, each of the tickets for the nodes 200, 206 and 208 associated with the network device 204 have the same prefix. A prefix can be assigned to the network device 204. The network device 204 can be configured to assign tickets with the prefix to the nodes associated with the network device 204.

In an exemplary embodiment, an additional network device uses a prefix of the ticket to forward the information packet. In the FIG. 2 example, the network devices 210, 212 and 214 forward information packets having tickets with the prefix 200000A11 to network device 204 which sends the information packets to the node 200. Since the prefix is used for forwarding, only a single entry in a forwarding table is required for all nodes associated with the network device 204. This can simplify the forwarding of information packets within the computer network system. For example, if one-hundred nodes are connected to each network device, the reduction in the data in the forwarding table is hundredfold. This can simplify the forwarding tables used in computer network systems that interconnect a large number of nodes.

A fixed-size prefix can be used. A fixed-sized prefix allows for a single prefix check to be done in addition to the normal full length check into the forwarding table.

The forwarding table size of the network device can place an upper bound on the number of nodes that can be supported using the computer network system. When the destination addresses are Ethernet addresses, the forwarding table cannot be significantly compressed. The use of tickets allows for the introduction of structures, such as prefixes in the forwarding tables. One means of ticket allocation is the use of sequential numbers. To ensure uniqueness, each switch can, for example, be allocated a unique prefix and, hence, has a range of tickets to be managed. Further structure in the tickets can also be used. For example, a field in the prefix can indicate a group of network devices.

The additional network devices can be configured to examine the ticket for the source node in the information packet to update the forwarding table with the prefix of the ticket.

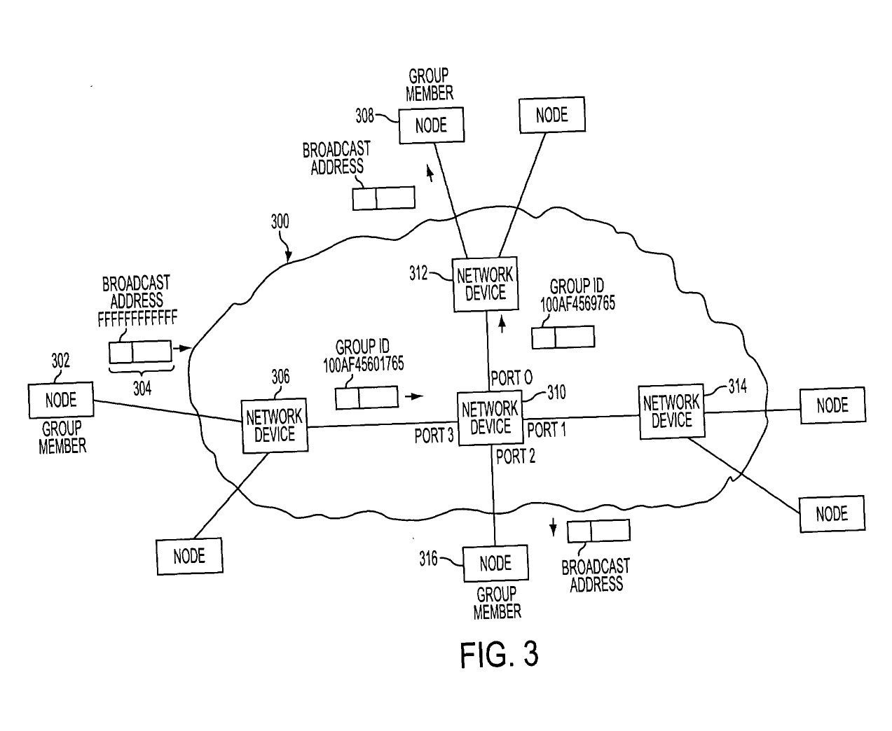

In an exemplary embodiment, the destination address is a broadcast address and the address indicator is a group identifier. In the FIG. 3 example, node 302 sends an information packet 304 including a broadcast address to a network device 306. The network device 306 converts the destination address (broadcast address) into a group identifier and forwards the information packet. In the FIG. 3 example, the destination address is the broadcast address and a group of nodes including the destination node 308 is identified by the group identifier. Node 302 has its broadcast address translated into a group identifier. The network devices, including network device 310, 312 and 314, need only forward the packets to the nodes which are members of the group, in this case, nodes 308 and 316. Thus, for example, the node device 310 forwards the packet with the group identifier to network device 312. Network device 312 converts the group identifier back into the broadcast address and sends the information packet to the node 308. The network device 310 also translates the group identifier into a broadcast address and sends the information packet to node 316. In the example of FIG. 3, the broadcast packet sent into the computer network 300 does not result in every node associated with the computer network system 300 receiving the information packet. In this example, the amount of traffic received by network devices in the computer network system and the nodes connected to the computer network system is significantly reduced.

In an exemplary embodiment, the forwarding tables for the network devices can use the entire group identifier in forwarding the packets. In this example, since the entire field ordinarily used for the destination address is used for the group identifier, a large number of groupings are available.

In an exemplary embodiment, the group identifier identifies a logical LAN. A large number of logical LANs are enabled using group identifiers. The computer network system need not be limited by the number of logical LANs available with the VLAN specification. The logical LANs and thus the group identifiers can be statically assigned.

In an exemplary embodiment, the computer network system uses a link-level protocol for the information packet. The link-level protocol is a data link-protocol. In one example, the information packet is an Ethernet packet.

To control the distribution of information packets using group identifiers, a distribution tree can be associated with each multicast group identifier. For the interconnection of network devices using forwarding tables within a computer network system, an arrangement called a spanning tree can be used. The spanning tree can ensure that there are no loops within the topology which would cause an information packet to be forwarded endlessly. For the multicast distribution tree, a spanning tree can be pruned so that the information packets having the group identifier only go to specific nodes and network devices. Such a pruning algorithm is described for a number of multicast distribution systems, such as the GARP Multicast Registration Protocol (GMRP) of the Generic Attribute Registration Protocol (GARP).

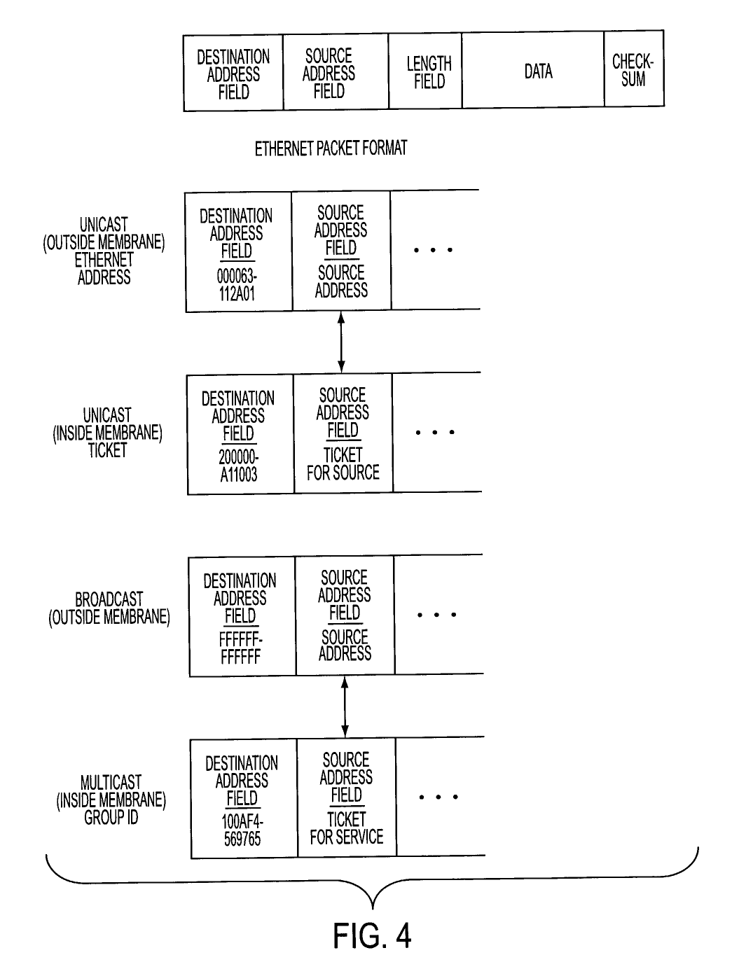

In an exemplary embodiment, an address indicator replaces the destination address in the address destination field of the information packet. In the example of FIG. 4, the ticket replaces an Ethernet address in a unicast Ethernet packet. The group identifier replaces the broadcast address in the destination address field. In both cases, the destination address is replaced by an address indicator.

In an exemplary embodiment, the address indicator is a local Ethernet address. In the Ethernet packet protocol, the second bit of the first octet of an Ethernet address indicates whether the Ethernet address is local. If the global/local bit is set to one and the address isn't a broadcast address, then the address is a local address. The use of local addresses for tickets allows the network devices within the computer network system to easily distinguish between tickets using local addresses and the externally-used destination addresses using global addresses.

As described in the patent application entitled “Method And Device For Use With A Virtual Network”, of David Andrew Thomas (Attorney Docket No. HP-10014758), filed on even date herewith, and incorporated herein by reference, the present system is compatible with the VLAN specification. In an exemplary embodiment, the destination address and a virtual network identifier, such as a VLAN identifier, are translated into an address indicator for use within the computer network system.

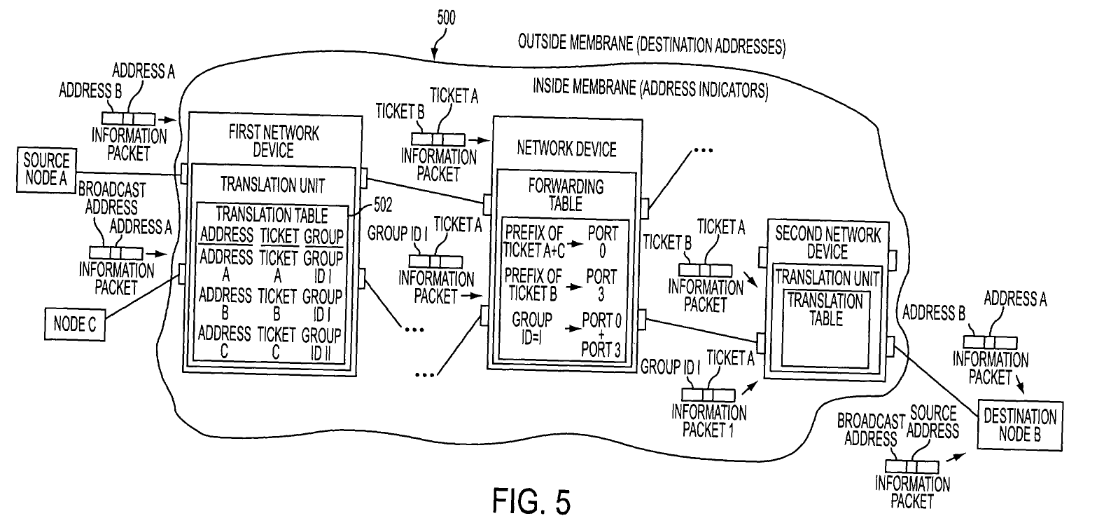

FIG. 5 is a diagram that illustrates an exemplary embodiment of the present invention. FIG. 5 shows the use of address indicators (tickets and group identifiers) within a computer network system. The translation table 502 is arranged with a correspondence between addresses, tickets and group identifiers. When the destination address is a broadcast address, the source address is used to determine a group identifier to replace the destination address in the information packet. When the destination address is a specific node address, the destination address is used to determine a ticket to replace the destination address in the information packet. When the destination address is a specific node address, the group identifier associated with destination address is checked to make sure that it matches the group identifier associated with source address. If the group identifiers do not match, the information packet is dropped. This provides security for the computer network system since unauthorized communications outside of the group are prevented. In the FIG. 5 example, the source address can be used to determine a ticket to replace the source address in the information packet.

An exemplary embodiment of the present invention is a network device using an address indicator, comprising first and second ports. For example, the network device 102 includes a first port 124 and a second port 126. The network device can be configured to receive an information packet, such as information packet 104, including a destination address across the first port. The network device includes a translation table, such as translation table 100, for use in translating the destination address into an address indicator, which is used to relate the destination address in the information packet and to denote a destination node specified by the destination address. The network device can be configured to transfer the information packet, including the address indicator, across the second port.

In one example, the network device is configured to check to ensure that a source node and destination node belong to the same group before forwarding the information packet. The network device can be configured to translate a source address into an additional address indicator that replaces the source address in the information packet.

In one example, the address indicator is a ticket that indicates a single destination node. Multiple tickets identifying nodes associated with the network device have a common prefix. In one example, tickets are assigned so that a ticket prefix can be used to forward the information packet.

The destination address can be a broadcast address, and the address indicator can be a group identifier. The group identifier can identify a logical LAN.

In one example, a link-level protocol is used for the information packet. The information packet can be an Ethernet packet. In one example, the address indicator replaces the destination address in a destination address field of the information packet. In an exemplary embodiment, the address indicator is a local Ethernet address.

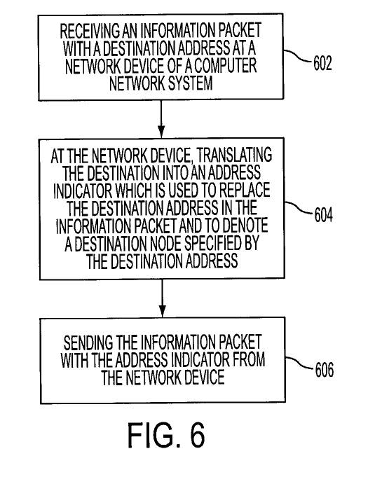

An exemplary method for controlling communication in a computer network system using an address indicator comprises receiving an information packet with a destination address at a network device of the computer network system, such as in step 602 of FIG. 6. The method comprises, at the network device, translating the destination address into an address indicator which is used to replace the destination address in the information packet and to denote a destination node specified by the destination address, such as in step 604 of FIG. 6. The information packet can be sent with the address indicator from the network device, such as in step 604 of FIG. 6.

The method can include determining whether a source node and destination node belong to the same group before forwarding the information packet. The method can include translating a source address into an additional address indicator that replaces the source address in the information packet.

In one example, the address indicator is a ticket that indicates a single destination node. Tickets identifying nodes associated with the network device can have a common prefix. The method can also include assigning tickets so that a ticket prefix can be used to forward the information packet.

In one example, the destination address is a broadcast address, and the address indicator is a group identifier. The group identifier can identify a logical LAN.

In one example, a link-level protocol is used for the information packet. The information packet can be an Ethernet packet. The method can include replacing the destination address in a destination address field of the information packet with an address indication. In one example, the address indicator is a local Ethernet address.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A computer network system for interconnecting nodes using an address indicator, comprising:
a first network device configured to receive an information packet including a destination address from a source node, the first network device including a first translation table for use in translating the destination address into an address indicator which is used in the computer network system to replace the destination address in the information packet and to denote a destination node specified by the destination address; and
a second network device configured to receive the information packet including the address indicator, the second network device including a second translation table for use in translating the address indicator into the destination address, the second network device being configured to send the information packet including the destination address to the destination node denoted by the address indicator.

2. The computer network system of claim 1, wherein the first network device is configured to determine whether the source node and destination node belong to the same group before forwarding the information packet

3. The computer network system of claim 1, wherein the first network device is configured to translate a source address into an additional address indicator that replaces the source address in the information packet.

4. The computer network system of claim 3, wherein the second network device is configured to translate the additional address indicator into the source address, and to use the source address to replace the address indicator in the information packet.

5. The computer network system of claim 1, wherein the address indicator is a ticket that indicates a single destination node.

6. The computer network system of claim 5, wherein multiple tickets identifying nodes associated with the second network device have a common prefix, the multiple tickets including the ticket for the single destination node.

7. The computer network system of claim 5, further comprising an additional network device that uses a prefix of the ticket to forward the information packet.

8. The computer network system of claim 1, wherein the destination address is a broadcast address, and wherein the address indicator is a group identifier.

9. The computer network system of claim 8, wherein the group identifier identifies a logical LAN.

10. The computer network system of claim 1, wherein the computer network system is configured to use a link-level protocol for the information packet.

11. The computer network system of claim 1, wherein the information packet is Ethernet packet.

12. The computer network system of claim 11, wherein the first network device is configured to replace the destination address in a destination address field of the information packet with the address indicator.

13. The computer network system of claim 12, wherein the address indicator is a local Ethernet address.

14. A network device using an address indicator, comprising:
first and second ports, the network device being configured to receive an information packet including a destination address across the first port; and
a translation unit including a translation table for use in translating the destination address into an address indicator which is used to replace the destination address in the information packet and to denote a destination node specified by the destination address, the network device being configured to transfer the information packet, including the address indicator, across the second port.

15. The network device of claim 14, wherein the network device is configured to check to ensure that a source node and destination node belong to the same group before forwarding the information packet

16. The computer network device of claim 14, wherein the network device is configured to translate a source address into an additional address indicator and to use the additional address indicator to replace the source address in the information packet.

17. The network device of claim 14, wherein the address indicator is a ticket that indicates a single destination node.

18. The network device of claim 14, wherein multiple tickets identifying nodes associated with the network device have a common prefix.

19. The network device of claim 14, wherein tickets are assigned so that a ticket prefix can be used to forward the information packet.

20. The network device of claim 14, wherein the destination address is a broadcast address, and wherein the address indicator is a group identifier.

21. The network device of claim 20, wherein the group identifier identifies a logical LAN.

22. The network device of claim 14, wherein a link-level protocol is used for the information packet.

23. The network device of claim 14, wherein the information packet is an Ethernet packet.

24. The network device of claim 23, wherein the network device is configured to replace the destination address in a destination address field of the information packet with the address indicator.

25. The network device of claim 23, wherein the address indicator is a local Ethernet address.

26. A method for controlling communication in a computer network system using an address indicator, comprising:
receiving an information packet with a destination address at a network device of the computer network system;
at the network device, translating the destination address into an address indicator which is used to replace the destination address in the information packet and to denote a destination node specified by the destination address; and
sending the information packet with the address indicator from the network device.

27. The method of claim 26, comprising:
checking to ensure that a source node and destination node belong to the same group before sending the information packet.

28. The method of claim 26, comprising:
translating a source address into an additional address indicator that replaces the source address in the information packet.

29. The method of claim 26, wherein the address indicator is a ticket that indicates a single destination node.

30. The method of claim 26, wherein tickets identifying nodes associated with the network device have a common prefix.

31. The method of claim 26, comprising:
assigning tickets so that a ticket prefix can be used to forward the information packet.

32. The method of claim 26, wherein the destination address is a broadcast address, and wherein the address indicator is a group identifier.

33. The method of claim 26, wherein the group identifier identifies a logical LAN.

34. The method of claim 26, wherein a link-level protocol is used for the information packet.

35. The method of claim 26, wherein the information packet is an Ethernet packet.

36. The method of claim 35, comprising:
replacing the destination address in a destination address field of the information packet with the address indicator.

37. The method of claim 35, wherein the address indicator is a local Ethernet address.
